(19) United States
(12) Patent Application Publication
(10) Pub. No.: US 2022/0161160 A1
(43) Pub. Date: May 26, 2022

(54) METHOD FOR PRODUCING A FILTER ELEMENT, FILTER ELEMENT, AND FILTER

(71) Applicant: ARGO-HYTOS Group AG, Baar (CH)

(72) Inventors: Jörg Stech, Bad Rappenau (DE); Joachim Fischer, Kraichtal (DE); Michael Melsa, Ubstadt-Weiher (DE)

(21) Appl. No.: 17/440,173

(22) PCT Filed: Mar. 11, 2020
(86) PCT No.: PCT/EP2020/056490

§ 371 Date: Sep. 16, 2021

(30) Foreign Application Priority Data
Mar. 21, 2019 (DE) 10 2019 107 316.2

(51) Int. Cl. B01D 29/11; B01D 29/21

(52) U.S. Cl. CPC B01D 29/111; B01D 2201/127; B01D 29/21

(57) ABSTRACT

A method for manufacturing a filter element for the filtration of a fluid, in particular a hydraulic fluid, comprising a filter bellows having a filter material through which a flow can pass, wherein the filter bellows is connected to an outer shell and the outer shell is printed prior to connecting to the filter bellows, wherein a carrier web made of a material of the outer shell is fed to the filter element, and is guided in a planar manner at least in one section, wherein the planar section uses the digital printing process and the printed carrier web is wrapped around the filter bellows and connected thereto to form the outer shell.

The invention relates to a method for manufacturing a filter element, a filter element and a filter. A filter element having the features of the preamble of claim 1 is known from WO 2003/33100 A1, for example.

Such filter elements are used, for example, in hydraulic systems, in particular in mobile hydraulics, such as construction or agricultural machinery, or in stationary applications, such as machine tools and processing machines. Here, the hydraulic systems must meet high requirements for the cleanliness of the hydraulic fluid. For this reason, the hydraulic fluid flows through the filter element during operation which retains the particles contained in the hydraulic fluid.

It is desirable to provide filter elements with a label, for example to indicate the manufacturing origin of the respective filter element. Various requirements which make the printing of such filter elements more difficult have to be considered here. For example, the printing must be chemically resistant and resistant to an aggressive environment. It must be avoided that any paint chips reach the hydraulic circuit. In terms of the process, the printing of a cylindrical body is difficult because the distance between the print head and the body must be controlled. The same is true for out-of-roundness of the body, which has to be compensated during printing.

In practice, these problems have so far been solved by printing using the pad printing process. Here, the printing ink is transferred from the printing plate to the body of the filter element by an elastic pad made of silicone rubber. The body of the filter element, known for example from WO 2003/33100 A1, comprises a filter bellows including a filter material and an outer shell. The outer shell of the well-known filter element is a shrink-wrapped plastic jacket that can be individually printed using the pad printing process.

Due to the shape of the pad, the layout options for printing are limited.

It is an object of the invention to specify a method for manufacturing a filter element that allows improved flexibility in the printing of the outer shell of the filter element. It is a further object of the invention to specify a filter element that provides the conditions for flexible printing without significantly affecting the technical characteristics of the filter element. Finally, it is an object of the invention to specify a filter with such a filter element.

With regard to the method, the object mentioned above is achieved according to the invention by the subject matter of claim 1, with regard to the filter element by the subject matter of claim 11 and with regard to the filter by the subject matter of claim 15.

In particular, the object is achieved by a method for manufacturing a filter element for the filtration of a fluid, in particular a hydraulic fluid, with a filter bellows. The filter bellows has a filter material through which a flow can pass and is connected to an outer shell. The outer shell is printed before it is connected to the filter bellows. In doing so, a carrier web made of the material of the outer shell is fed to the filter element. The carrier web is guided in a planar manner in at least one section. In the region of the planar section, the carrier web is printed using the digital printing process. The printed carrier web is then wrapped around the filter bellows and connected thereto to form the outer shell.

In contrast to the prior art, the finished filter element is not printed with the already connected outer shell, as in the pad printing process. Rather, the outer shell is printed using the digital printing process before it is connected to the filter element. The digital printing process is to be understood as a direct printing process in which the printed image is transferred directly from a file or in a corresponding manner to a printing machine without using a static printing plate.

The invention has various advantages.

Due to the digital printing process, there are practically no restrictions with regard to the layout of the printing and the information to be printed. The digital printing process enables individual printing and individual labelling of the filter elements, which are quantity-independent, since no set-up process is required when changing batches. In addition, multi-color printing is possible without any problems, so that images, graphics, instructions, etc. can be applied onto the filter element with sufficient precision. The digital printing process enables material number labelling during printing, thus eliminating the need for conventional laser marking. The same applies to printing the year of manufacture, which eliminates the need for stamping or laser marking. The digital printing process allows consecutive numbering of batch numbers, which was not possible with the previous printing process.

In connection with the digital printing process, a further advantage of the invention is that the outer shell is printed before it is connected to the filter bellows, wherein a carrier web of the material of the outer shell is fed to the filter element and is guided in a planar manner at least in one section. The printing of the carrier web in the digital printing process in the region of the planar section avoids printing problems due to the curved shape of the filter element.

Preferred embodiments of the invention are specified in the subclaims.

Preferably, the carrier web is fed continuously to the filter element, whereby fast production times are achieved.

If the material of the outer shell has a fineness which is coarser than the fineness of the filter material, it is avoided that the flow properties of the filter element are impaired.

The material of the outer shell may comprise a non-woven material, in particular a protective non-woven material. It has been shown that such materials have good printability and at the same time have good flow properties. It is particularly preferred if a non-woven material present in the filter material is also used as the material for the outer shell, because this ensures that the flow properties are practically unchanged.

With regard to the digital printing process, it is advantageous if it comprises inkjet printing, as this enables the use of the informative inscriptions commonly used in industrial applications and enables increased layout requirements to be met.

Preferably, at least one print head is arranged in the region of the planar section, so that digital printing is possible in the region of the planar section. It is further preferred that at least one dispensing head, through which an adhesive for connecting the outer shell to the filter bellows can be fed, is arranged downstream of the region of the planar section in the feed direction. This enables the printing of the carrier web and thus the later outer shell as well as the connection of the outer shell to the filter bellows to be carried out on the same machine.

It is also possible to fasten the outer shell to the filter bellows separately and independently of the printing.

In a particularly preferred embodiment of the method, a first adhesive bead is applied to the filter bellows for connecting the outer shell to the filter bellows. A first layer of the outer shell is brought into contact with the first adhesive bead to form a first connecting seam. This has the advantage that the carrier web or, respectively, the later outer shell can be connected locally to the filter bellows in a secure position before the outer shell is wrapped around the filter bellows.

Further preferred, a second adhesive bead is applied to the outside of the first layer. The second adhesive bead extends along the first connecting seam and covers it at least partially, in particular completely. This ensures that the two adhesive beads and then, in the finished state, the correspondingly extending connecting seams block portions as small as possible of the filter element area through which a flow can pass. In other words, the two adhesive beads are positioned such that the resulting connecting seams are arranged one above the other in the radial direction of the filter element. It is possible that the connecting seams protrude slightly laterally above each other, i.e. are not completely congruent. In any case, the connecting seams overlap at least partially. The completely congruent arrangement is the optimum arrangement in which the smallest area through which the flow can pass is blocked.

Further preferred, the outer shell is preferably wrapped around the filter bellows in such a manner that in the region of the first connecting seam, the outer shell is multi-layered, in particular double-layered. A further layer, in particular the second layer, of the outer shell is brought into contact with the second adhesive bead to form the second connecting seam. Thereby, the outer shell is closed.

The carrier web can be cut before wrapping or after wrapping to complete the outer shell. For example, the carrier web can be cut after the first fixation through the first adhesive bead.

With regard to the filter element, the object mentioned above is specifically achieved by a filter element for the filtration of a fluid, in particular hydraulic fluid, with a filter bellows that has a filter material through which a flow can pass. The filter element has an outer shell which is connected to the filter bellows in a fastening area. At least in the fastening area, the outer shell is arranged in several layers, in particular double layers, and has at least one first connecting seam and one second connecting seam in the fastening area. The second connecting seam is guided along the first connecting seam. The first connecting seam is arranged between the filter bellows and a first layer of the outer shell. The second connecting seam is arranged between the first layer of the outer shell and a second layer of the outer shell. The first and second connecting seams overlap at least partially, in particular completely.

With regard to the advantages, reference is made to the corresponding explanations in connection with the manufacturing method. The filter element according to the invention has the particular advantage that it offers the condition that the outer shell can be printed before the filter element is finally finished without experiencing any significant impairment of the technical properties of the filter element. This is achieved by the fastening of the outer shell to the filter bellows, which is configured such that the outer shell can first be printed and then connected to the filter bellows. By decoupling the printing on the outer shell and the completion of the filter element, the degree of flexibility of the printing is improved. In this respect, the filter element according to the invention offers the condition for improved customer-specific individual printability.

The filter element according to the invention is not limited to the improved printability as a possible application.

In addition, in connection with the filter element as well as with the manufacturing process, it is disclosed that in a particularly preferred embodiment, the two connecting seams run parallel to the longitudinal axis of the filter element, in particular of the cylindrical filter element.

In another preferred embodiment, the filter material has a plurality of filter layers and a protective fabric which is arranged radially on the outside of the filter layers and connected to the outer shell. Filter layers may include a prefilter layer, a fine filter layer and a protective non-woven material. The protective fabric is preferably formed as a hybrid protective fabric.

Preferably, the material of the outer shell corresponds to one of the filter layers, in particular the protective non-woven material. With regard to the advantages, reference is made to the corresponding explanations in connection with the manufacturing process.

Further preferred, a supporting fabric, in particular a hybrid supporting fabric, is arranged radially on the inside of the filter layers.

The invention is explained in more detail below by means of an exemplary embodiment with reference to the accompanying schematic drawings. In the figures:

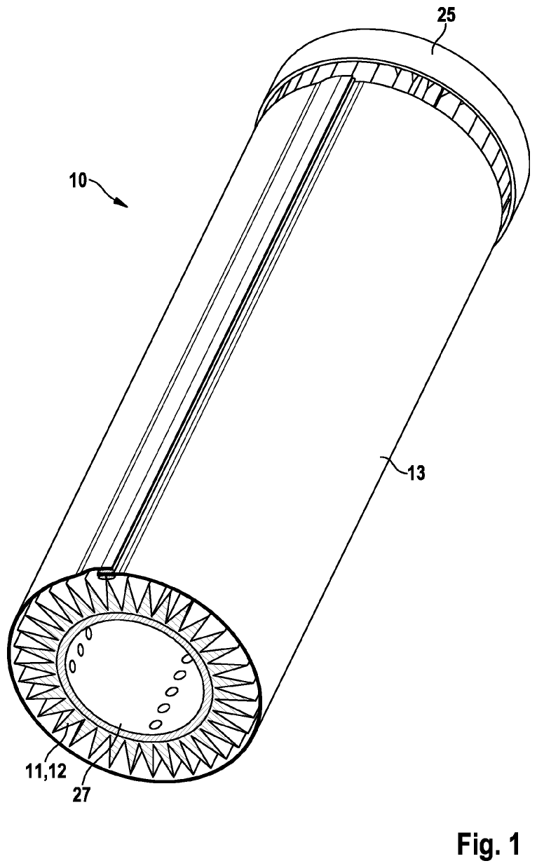

FIG. 1 shows a perspective view of a cut filter element according to a preferred exemplary embodiment of the invention;

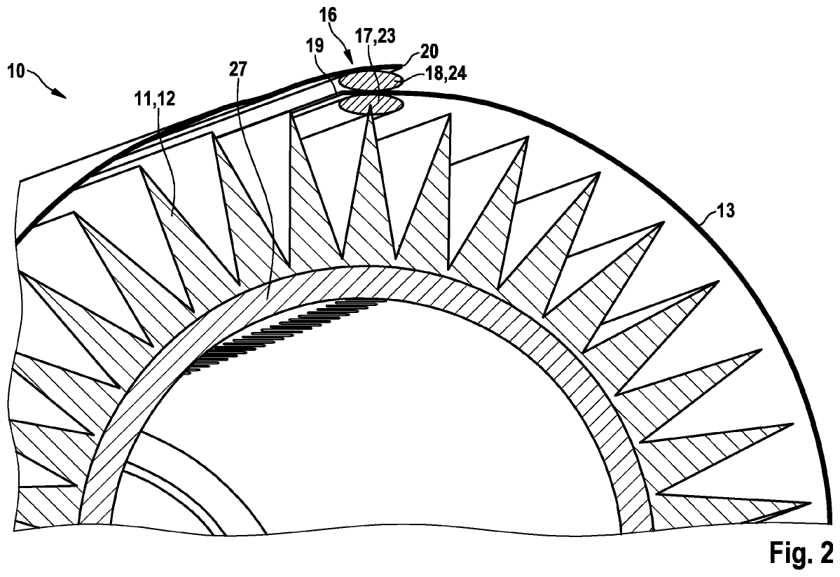

FIG. 2 shows a detailed view of the fastening area of the filter element according to FIG. 1;

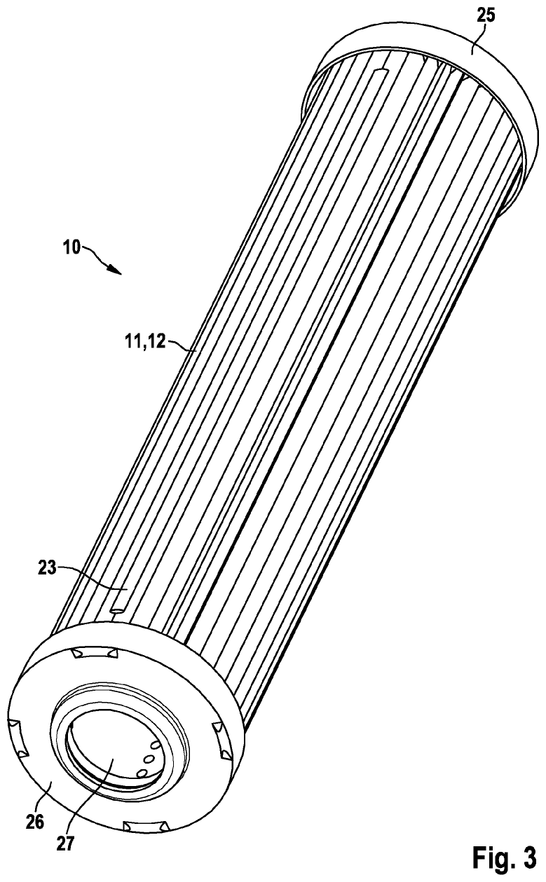

FIG. 3 shows a perspective view of the filter element according to FIG. 1 during the manufacturing process (first adhesive bead);

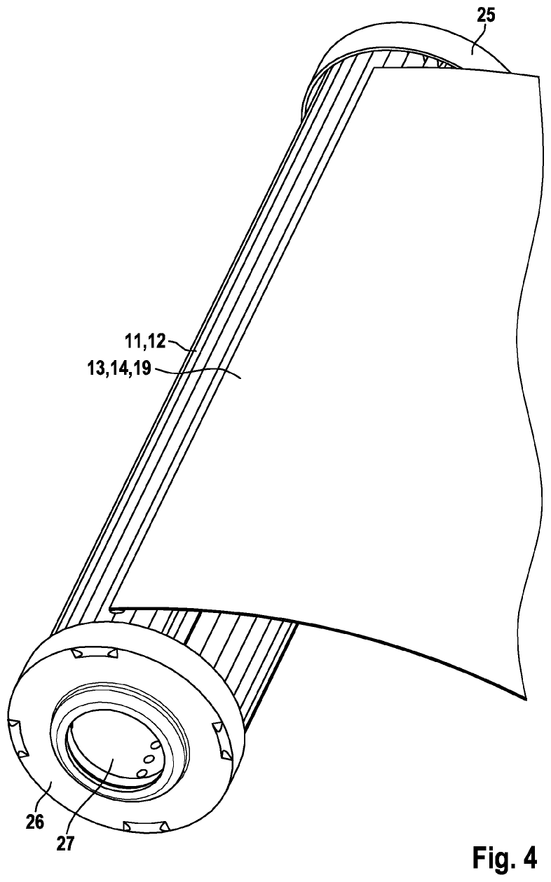

FIG. 4 shows a perspective view of the filter element according to FIG. 1 during the adhesive process (fixing of the carrier web);

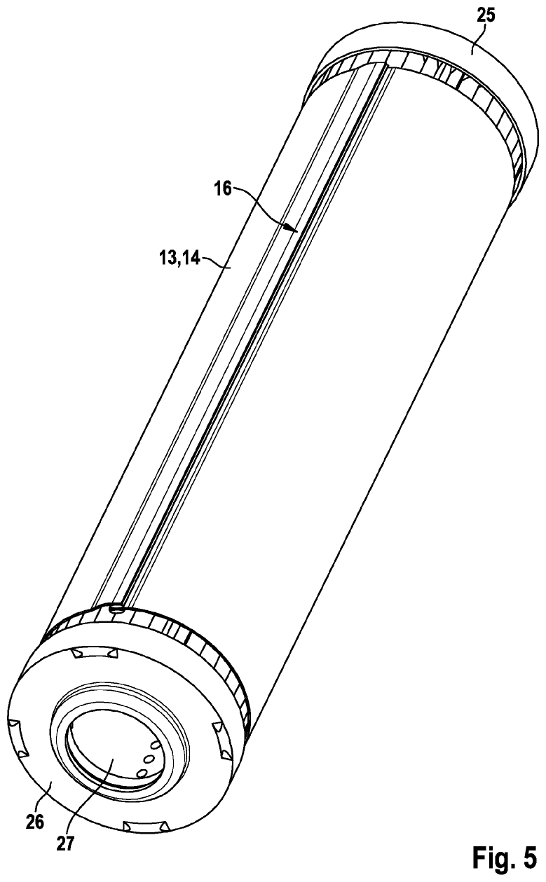

FIG. 5 shows a perspective view of the finished filter element according to FIG. 1 in the uncut state, and

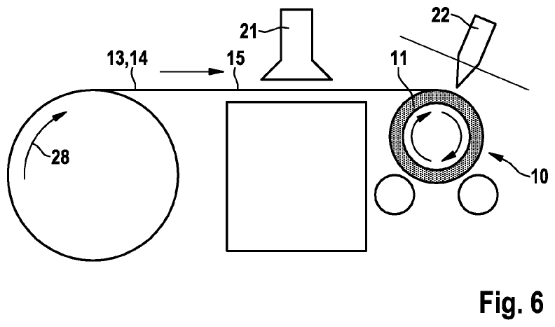

FIG. 6 shows a schematic view of a manufacturing plant for carrying out a method according to an exemplary embodiment according to the invention.

FIGS. 1, 2 show a filter element 10 manufactured according to a method according to the invention. The filter element 10 is provided for the filtration of hydraulic fluid. Other applications for the filter element are conceivable. The filter element 10 has a hollow cylindrical shape and is constructed as follows. Between the end plates 25, 26, which limit the filter element 10 in axial direction, the filter bellows 11 is arranged.

The filter bellows 11 is formed from a folded filter material 12, the folds of which extend in the circumferential direction and in the longitudinal direction of the filter element 10. The filter bellows 11 is connected radially on the inside to a perforated frame 27, which provides full-surface support for the filter bellows 11 to ensure collapse pressure stability.

The filter material 12 has a plurality of filter layers through which the hydraulic fluid flows during operation and which retain the particles contained in the hydraulic fluid. For example, the filter layers, which are not shown, may include a prefilter layer for separating coarse particles and increasing dirt capacity, a fine-filter layer for separating fine particles and improving oil cleanliness, and a protective non-woven material for protecting the fine-filter layer and improving differential pressure and flow fatigue stability. In addition, a safety fabric can be used as additional protection for filter elements with increased differential pressure stability.

The filter material 12 is connected radially on the inside and radially on the outside to a protective fabric (radially on the outside) and a supporting fabric (radially on the inside). The radially outer protective fabric is provided to protect the filter materials against mechanical damage from the outside and prevents electrostatic charges. In addition, the protective fabric keeps the folds open for free inflow. The protective fabric is preferably a hybrid protective fabric made of metal and plastic threads. The supporting fabric is arranged radially on the inside and also serves to support the filter materials and to keep the folds open for the free outflow of the fluid to be cleaned. In addition, the supporting fabric is provided to prevent electrostatic charges and improves flow fatigue stability. In addition, a fabric sock can be provided radially further inwards, which, as a fine wire mesh, supports the folded filter material of filter elements with increased differential pressure stability.

The filter bellows 11 is connected radially on the outside to an outer shell 13. The outer shell 13 forms the outer surface of the filter element 10, which is optically visible when the filter element 10 is not installed. During operation, the hydraulic fluid or the fluid in general flows through the outer shell 13.

As shown in FIG. 2, the outer casing 13 is locally connected to the filter bellows 11 in a fastening area 16. The fastening area 16 runs parallel to the longitudinal axis of the filter element 10, in particular the cylindrical filter element 10. Another path of the fastening area 16 is possible.

As is further apparent from FIG. 2, the outer shell 13 is arranged in two layers in the fastening area 16. In other words, the longitudinal edges of the outer shell 13 overlap in the fastening area so that a first layer 19 of the outer shell 13 and a second layer 20 of the outer shell 13 are arranged one above the other there. The first layer 19 is arranged radially further inwards than the second layer 20 of the outer shell 13. In addition, there are two connecting seams, a first connecting seam 17 and a second connecting seam 18, in the fastening area 16. The two connecting seams 17, 18 run parallel to each other. The first connecting seam 17 runs along the second connecting seam 18.

To connect the outer shell 13 to the filter bellows 11, the first connecting seam 17 is arranged between the filter bellows 11 and the first layer 19 of the outer shell 13. Specifically, the first connecting seam 17 is firmly connected to a tip of a fold in the filter bellows 11. The second connecting seam 18 is arranged between the outside of the first layer 19 and the inside of the second layer 20 of the outer shell 13. This ensures that the outer shell 13 is firmly connected to the filter bellows 11 by the first connecting seam 17 on the one hand and closed by the second connecting seam 18 on the other hand, so that the outer shell 13 rests flatly against the filter bellows 11 in a secure manner.

As is further apparent from FIG. 2, the two connecting seams 17, 18 are arranged congruently. In other words, the two connecting seams 17, 18 overlap completely. This ensures that a minimum circumferential area of the filter element 10 is closed by the connecting seams 17, 18. It is conceivable that the connecting seams 17, 18 do not completely overlap but only partially overlap each other, which slightly increases the overall width of the connecting seams 17, 18 in comparison with the exemplary embodiment according to FIG. 2, for example due to manufacturing tolerances. A complete overlapping is the optimum condition. It is also possible that local deviations from the overlap along the connecting seams 17, 18 may occur during production.

The exemplary embodiment according to the invention of the method for manufacturing the filter element is illustrated by means of FIGS. 3 to 5 in connection with FIG. 6, which shows a schematic structure of a possible manufacturing plant for carrying out the method. FIG. 6 shows that in this method the outer shell 13 is printed before it is connected to the filter bellows 11. In doing so, a carrier web 14 is fed from a roll 28 to the filter element 10. The carrier web 14 is made of the material of the outer shell 13, for example the protective non-woven material. As clearly shown in FIG. 6, the carrier web 14 is guided in a planar manner on the way to the filter element 10 in at least one section 15. In the example shown in FIG. 6, a single planar section 15 is provided. Several planar sections 15 are possible. A print head 21, for example an ink jet print head 21, is arranged in the region of the planar section 15 so that the carrier web 14 in the region of the planar section 15 can be printed using the digital printing process. The printed carrier web 14 is then fixed to the filter bellows 11 and wrapped around it. The dispensing head 22 required to feed an adhesive material is arranged downstream of the planar section 15 in the feed direction.

Fastening or connecting the carrier web 14 and thus the later outer shell 13 is described in more detail by means of FIGS. 3 to 5.

The fastening of the outer casing 13 is disclosed and claimed in connection with the manufacturing method, in particular the printing process, described in FIG. 6.

In addition, the fastening method of the outer shell 13 is also disclosed and described independently of the printing method described in FIG. 6, so that it is possible to manufacture a filter element with an outer shell 13 correspondingly connected to the filter bellows 11 without printing on the outer shell 13.

As shown in FIG. 3, in the first step, the first adhesive bead 23 is preferably applied along the folds of the filter bellows 11, i.e. in the longitudinal direction of the filter element 10. In order to impair or reduce the effective flow area of the filter element 10 as little as possible, it is provided that the first adhesive bead 23 is applied onto the tip of a fold of the filter bellows 11. The first adhesive bead 23 does not necessarily have to extend over the entire length of the filter element 10, as shown in FIG. 3.

As shown in FIG. 4, in the second step, the first layer 19 of the carrier web 14 or, respectively, then the outer shell 13, is brought into contact with the first adhesive bead 23 to form the first connecting seam 17. Specifically, a longitudinal edge of the outer shell 13 is arranged along the first adhesive bead 23 such that the longitudinal edge of the outer shell 13 and the first adhesive bead 23 are approximately parallel. The outer shell 13 thus forms a first layer 19, which overlaps the adhesive bead 23 and is thus is being connected thereto. Thereby, the outer shell 13 is fixed to the filter bellows 11 before wrapping.

FIG. 5 shows that the carrier web 14 or, respectively, then the outer shell 13 is wrapped completely around the filter bellows 11 in the circumferential direction, so that the ends of the carrier web 14 or, respectively, then the outer shell 13 overlap each other in the fastening area 16 (see FIGS. 1, 2) and thus form a double-layer arrangement. Specifically, the second longitudinal end of the cut carrier web 14 overlaps the second adhesive bead 24 (see FIGS. 1, 2), which has meanwhile been applied to the outside of the first layer 19, so that the carrier web 14 is closed and thus forms the outer shell 13, which is firmly connected to the filter bellows 11.

In summary, the invention and the exemplary embodiment of the invention described above enable a significant improvement in the visual appearance of the filter element and thus in the outer label surface which can be designed and determined by the user. It is now also possible to produce full-surface, colored prints on customer request at any time and in very good print quality and color strength. In addition to the customer logo and type designation, operating conditions or installation instructions can also be displayed on the label surface. This is an additional great added value for the user.

### REFERENCE LIST

10 Filter element
11 Filter bellows
12 Filter material
13 Outer shell
14 Carrier web
15 Planar section
16 Fastening area
17 First connecting seam
18 Second connecting seam
19 First layer of the outer shell
20 Second layer of outer shell
21 Print head
22 Dispensing head
23 First adhesive bead
24 Second adhesive bead
25 End plate
26 End plate
27 Perforated frame
28 Roll

1.-15. (canceled)

16. A method for manufacturing a filter element for filtration of a fluid, comprising:
wrapping and connecting an outer shell on a filter bellows, the filter bellows having a filter material through which a flow of the fluid can pass, the outer shell manufactured prior to connecting to the filter bellows by,
feeding a carrier web made of a material of the outer shell to the filter element;
guiding the carrier web in a planar manner at least in one section; and
printing the carrier web in a region of the planar section using a digital printing process.

17. The method for manufacturing the filter element according to claim 16, wherein the carrier web is continuously fed to the filter element.

18. The method for manufacturing the filter element according to claim 16, wherein the material of the outer shell has a fineness coarser than a fineness of the filter material.

19. The method for manufacturing the filter element according to claim 16, wherein the material of the outer shell includes a non-woven material.

20. The method for manufacturing the filter element according claim 16, wherein the digital printing process includes ink jet printing.

21. The method for manufacturing the filter element according to claim 16, wherein at least one print head is configured and arranged in the region of the planar section.

22. The method for manufacturing the filter element according to claim 16, wherein the carrier web is continuously fed to the filter element, and wherein the digital printing process includes ink jet printing.

23. The method for manufacturing the filter element according to claim 16, wherein the carrier web is continuously fed to the filter element, wherein the digital printing process includes ink jet printing, and wherein at least one print head is configured and arranged in the region of the planar section.

24. The method for manufacturing the filter element according to claim 16, further comprising:
dispensing through a dosing head an adhesive for connecting the outer shell to the filter bellows, wherein the dosing head is configured and arranged downstream of the region of the planar section in a feed direction.

25. The method for manufacturing the filter element according to claim 24, further comprising:
applying the dispensed adhesive as a first adhesive bead onto the filter bellows to connect the outer shell to the filter bellows; and
bringing a first layer of the outer shell into contact with the first adhesive bead to form a first connecting seam.

26. The method for manufacturing the filter element according to claim 25, wherein wrapping and connecting the outer shell on the filter bellows further comprises:
wrapping around the filter bellows in such a manner that the outer shell is multi-layered in a region of the first connecting seam, and
bringing a second layer of the outer shell into contact with a second adhesive bead to form a second connecting seam.

27. The method for manufacturing the filter element according to claim 25, further comprising:
applying a second adhesive bead onto the outside of the first layer, wherein the second adhesive bead extends along the first connecting seam and at least partially covers the latter.

28. The method for manufacturing the filter element according to claim 27, wherein wrapping and connecting the outer shell on the filter bellows further comprises:
wrapping around the filter bellows in such a manner that the outer shell is multi-layered in a region of the first connecting seam, and
bringing a second layer of the outer shell into contact with the second adhesive bead to form a second connecting seam.

29. A method for manufacturing a filter element for filtration of a fluid, comprising:
wrapping and connecting an outer shell on a filter bellows, the filter bellows having a filter material through which a flow of the fluid can pass, the outer shell manufactured prior to connecting to the filter bellows by,
feeding a carrier web made of a material of the outer shell to the filter element;
guiding the carrier web in a planar manner at least in one section; and
printing the carrier web in a region of the planar section using a digital printing process, wherein the carrier web is continuously fed to the filter element, and wherein the material of the outer shell has a fineness coarser than a fineness of the filter material.

30. A filter element for the filtration of a fluid comprising:
a filter bellows having a filter material through which a flow of the fluid can pass; and
an outer shell connected to the filter bellows in a fastening area, the outer shell configured and arranged in a multi-layer manner in the fastening area, wherein a first connecting seam of the outer shell is configured and arranged in the fastening area between the filter bellows and a first layer of the outer shell, and a second connecting seam of the outer shell is configured and arranged in the fastening area between the first layer of the outer shell and a second layer of the outer shell, wherein the second connecting seam is guided along the first connecting seam, and wherein the first and second connecting seams overlap each other at least partially.

31. The filter element according to claim 30, wherein the filter material comprises:
a plurality of filter layers including (i) a pre-filter layer, (ii) a fine-filter layer, (iii) a protective non-woven material, and (iv) a protective fabric, the protective fabric filter layer configured and arranged radially on the outside of the filter layers and connected to the outer shell.

32. The filter element according to claim 31, wherein a material of the outer shell corresponds to one of the plurality of filter layers and includes the protective non-woven material.

33. The filter element according to claim 30, wherein a material of the outer shell includes a protective non-woven material and corresponds to one of a plurality of filter layers of the filter material.

34. The filter element according to claim 30, further comprising a hybrid supporting fabric arranged radially on an inside of the filter layers.

35. The filter element according to claim 30, wherein the fluid is a hydraulic fluid.
